(19) United States
(12) Patent Application Publication
(10) Pub. No.: US 2017/0212935 A1
(43) Pub. Date: Jul. 27, 2017

(54) DATA MANAGEMENT APPARATUS AND DATA MANAGEMENT METHOD

(71) Applicant: HITACHI, LTD., Tokyo (JP)

(72) Inventors: Jun IRIE, Tokyo (JP); Masato MATSUMOTO, Tokyo (JP)

(73) Assignee: HITACHI, LTD., Tokyo (JP)

(21) Appl. No.: 15/329,067

(22) PCT Filed: Jan. 9, 2015
(86) PCT No.: PCT/JP2015/050475

§ 371 Date: Jan. 25, 2017

(51) Int. Cl. G06F 17/30

(52) U.S. Cl. CPC G06F 17/30501; G06F 17/30551

(57) ABSTRACT

A high-precision data search function is provided by calculating feature values of time series data in a unit that is different from the unit of compression, while conserving data storage capacity. A data management apparatus 100 comprises a data reception unit 111 which acquires data in a first unit from time series data that was input, a data compression unit 114 which compresses the data acquired in the first unit, and a feature value calculation unit 113 which calculates a feature value indicating a feature of data acquired in a second unit that differs from the first unit.

### TECHNICAL FIELD

The present invention relates to a data management apparatus and a data management method, and can be suitably applied to a data management apparatus and a data management method for managing time series data.

### BACKGROUND ART

In recent years, enormous volumes of data are being generated moment by moment and accumulated, and being utilized for various types of businesses. The accumulation of such time series data is becoming voluminous, and the enlargement of the storage capacity and the prolongation of the search process are becoming problematic. Thus, in order to conserve the storage capacity of such voluminous time series data, data is being compressed and stored for each predetermined duration.

Moreover, in order to efficiently search for data among the voluminous time series data, a scheme is being adopted where, upon storing data, a feature value is calculated for each compressed data, and compressed data and the calculated feature value are associated, and the time series data to be searched is narrowed down based on the feature value. For example, PTL 1 describes changing the size of the data block, which is the unit of compression, according to the user's search scope or search period, and calculating the feature value of the data block.

### CITATION LIST

### Patent Literature

PTL 1: Japanese Patent Application Publication No. 2011-221799

### SUMMARY OF THE INVENTION

### Problems to be Solved by the Invention

Normally, since large amounts of time series data are stored by being highly compressed, data is compressed in large units such as every hour or every day. In the foregoing case, there is a problem in that it is not possible to confirm the contents of data in smaller units, such as every minute, and efficiently perform a more detailed high-precision data analysis. Meanwhile, when data is compressed in small units, because the compression effect will deteriorate, there is a problem in that the conservation of the storage capacity of the time series data cannot be realized. Even if the data block as the unit of compression is changed using the technology described in PTL 1, since one feature value is calculated for one data block, it is difficult to use the feature value to simultaneously conserve the data storage capacity and perform high-precision data analysis.

The present invention was devised in view of the foregoing points, and an object of this invention is to propose a data management apparatus and a data management method capable of providing a high-precision data search function by calculating feature values of time series data in a unit that is different from the unit of compression, while conserving data storage capacity.

### Means to Solve the Problems

In order to achieve the foregoing object, the present invention provides a data management apparatus comprising a data reception unit which acquires data in a first unit from time series data that was input, a data compression unit which compresses the data acquired in the first unit, and a feature value calculation unit which calculates a feature value indicating a feature of data acquired in a second unit that differs from the first unit.

Moreover, in order to achieve the foregoing object, the present invention additionally provides a data management method for managing time series data that was input comprising a step of a data reception unit acquiring data in a first unit from time series data that was input, a step of a data compression unit compressing the data acquired in the first unit, and a step of a feature value calculation unit calculating a feature value indicating a feature of data acquired in a second unit that differs from the first unit.

### Advantageous Effects of the Invention

According to the present invention, it is possible to provide a high-precision data search function by calculating feature values of time series data in a unit that is different from the unit of compression, while conserving data storage capacity.

### BRIEF DESCRIPTION OF DRAWINGS

FIG. 1 is a conceptual diagram explaining an overview of one embodiment of the present invention.

FIG. 2 is a block diagram showing a configuration of the data management apparatus according to the same embodiment.

FIG. 3 is a table showing an example of the time series data according to the same embodiment.

FIG. 4 is a conceptual diagram showing an example of the search query according to the same embodiment.

FIG. 5 is a table showing an example of the time series data information according to the same embodiment.

FIG. 6 is a table showing an example of the feature value information according to the same embodiment.

FIG. 7 is a table showing an example of the feature value reference information according to the same embodiment.

FIG. 8 is a table showing an example of the feature value index information according to the same embodiment.

FIG. 9 is a conceptual diagram showing an example of the index data according to the same embodiment.

FIG. 10 is a table showing an example of the search history information according to the same embodiment.

FIG. 11 is a table showing an example of the feature value calculation information according to the same embodiment.

FIG. 12 is a flowchart showing the feature value calculation processing according to the same embodiment.

FIG. 13 is a flowchart showing the feature value unit of compression determination processing according to the same embodiment.

FIG. 14 is a flowchart showing the second feature value calculation processing according to the same embodiment.

FIG. 15 is a flowchart showing the second feature value unit of calculation determination processing according to the same embodiment.

FIG. 16 is a flowchart showing the third feature value calculation processing according to the same embodiment.

FIG. 17 is a flowchart showing the third feature value calculation method determination processing according to the same embodiment.

FIG. 18 is a flowchart showing the feature value compression processing according to the same embodiment.

FIG. 19 is a flowchart showing the feature value unit of compression determination processing according to the same embodiment.

FIG. 20 is a flowchart showing the feature value index reorganization processing according to the same embodiment.

FIG. 21 is a flowchart showing the feature value index reorganization method determination processing according to the same embodiment.

FIG. 22 is a conceptual diagram showing an example of the feature value unit of calculation selection screen according to the same embodiment.

FIG. 23 is a conceptual diagram showing an example of the feature value unit of calculation selection screen according to the same embodiment.

### DESCRIPTION OF EMBODIMENTS

An embodiment of the present invention is now explained in detail with reference to the appended drawings.

(1) Overview of this Embodiment

The overview of this embodiment is foremost explained. Conventionally, in order to efficiently search for data among voluminous time series data, a scheme is being adopted where, upon storing data, data is compressed and a feature value is calculated for the data block as the unit of compression, and compressed data and the calculated feature value are associated. Normally, data is compressed in large units such as every hour or every day in order to conserve the storage capacity. In the foregoing case, there is a problem in that it is not possible to confirm the contents of data in a smaller unit of compression, such as every minute, and efficiently perform a more detailed high-precision data analysis.

As one example of conventional technology, explained is a case of associating one feature value with a data block in which the unit of compression is in 1-hour units. For example, let it be assumed that the user wishes to confirm the contents of data for a certain 15-minute period among the data blocks that are compressed in 1-hour units. In the foregoing case, foremost, data blocks that coincide with a predetermined search condition are identified based on information of a plurality of feature values associated with a plurality of data blocks. Subsequently, the compressed data blocks are decompressed, and the feature values of the contents of the data for a certain 15-minute period are calculated with regard to the decompressed data blocks in order to confirm the contents of the data.

Accordingly, in order to confirm the data contents of a unit of time (for example 15 minutes) other than the compressed unit of time (for example 1 hour), the data blocks identified based on the information of the feature values need to be once decompressed, and then the feature values need to be calculated once again, and much time is required for conducting the search. Meanwhile, when the unit of time of compression is shortened, because the compression effect will deteriorate, there is a problem in that the data storage capacity cannot be conserved.

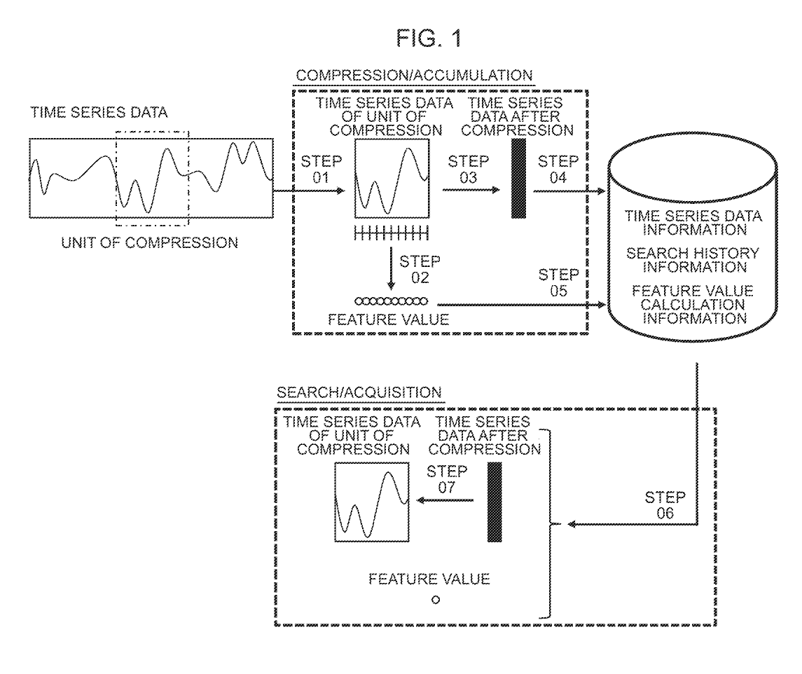

Thus, in this embodiment, as shown in FIG. 1, time series data is acquired in large units such as every hour or every day in the same manner as conventional technologies (STEP 01), and then the feature values of time series data are calculated in a unit that is smaller than the unit of compression of the time series data, such as every minute, (STEP 02). Subsequently, the time series data is compressed in large units (STEP 03), and the compressed time series data is stored in a storage device (STEP 04). Moreover, the feature values calculated in STEP 02 are stored in the storage device by being associated with the time series data (STEP 05).

By calculating the feature values of a unit of time that is smaller than the compressed unit of time, when searching for intended data among the stored data, the time series data or the feature value itself is searched by using, as the index, the information of the feature values calculated in a short duration (STEP 06), and the compressed time series data is decompressed (STEP 07).

In other words, by searching for information of feature values of a shorter duration, it will be possible to confirm the data contents of a unit of time that is smaller than the unit of time of the compressed data without having to decompress the compressed data. As described above, this embodiment aims to efficiently realize a high-precision data search function by calculating feature values of time series data in a unit that is smaller than the unit of compression, while conserving data storage capacity.

Moreover, when the processing of foregoing STEP 01 to STEP 07 is repeated, as shown in FIG. 1, time series data information, search history information, feature value information and other information are stored in the storage device. The various types of information stored in the storage device will be described later in detail. In this embodiment, in addition to the foregoing processing, the feature values and feature value indexes are reorganized based on the referral frequency of the feature values and feature value indexes included in the search history information. It is thereby possible to provide a high-speed and flexible search function in accordance with the user's request.

Specifically, the data management of time series data in this embodiment is configured from a first stage of compressing and storing the time series data (foregoing STEP 01 to STEP 5), a second stage of searching for the time series data or feature value itself and acquiring the time series data (foregoing STEP 06 to STEP 07), and a third stage of re-calculating or reorganizing the feature values or feature value indexes based on the search history information of the time series data or the referral frequency of the feature value. This is now explained in detail.

(2) Configuration of Data Management Apparatus

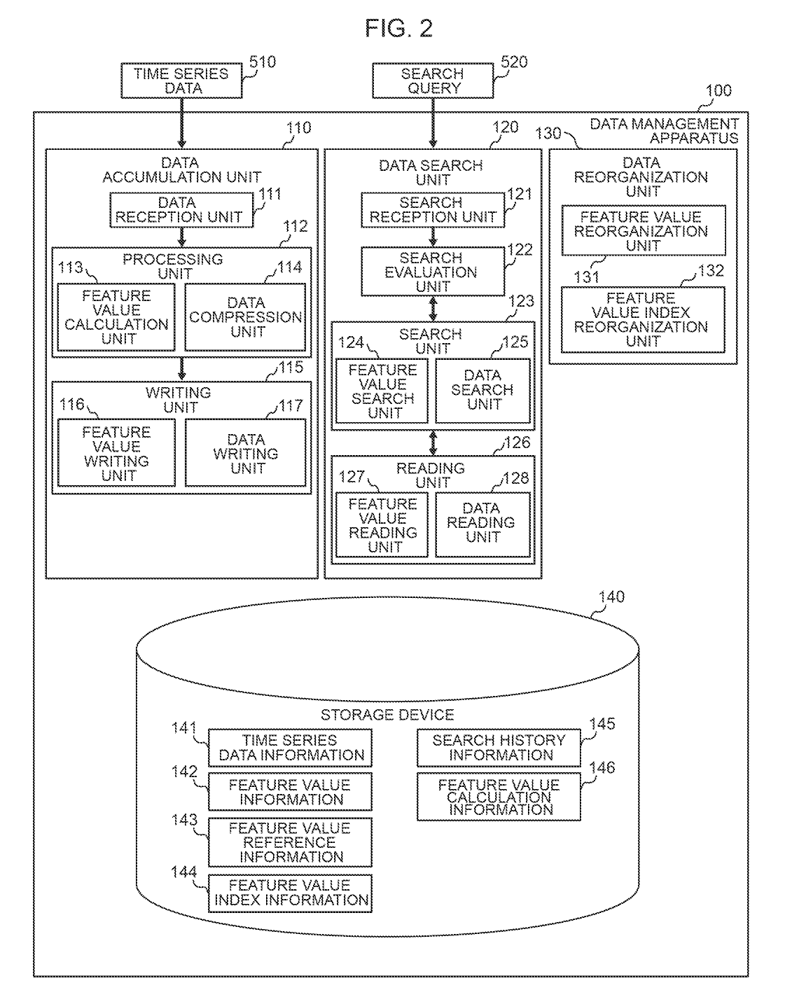

Referring to FIG. 2, the configuration of a data management apparatus 100 according to this embodiment is now explained. In the ensuing explanation, as an example of the time series data, a case where the speed information or location information of a taxi is stored in predetermined intervals is explained.

(2-1) Hardware Configuration of Data Management Apparatus

The data management apparatus 100 comprises a CPU, a memory and other information processing resources. The CPU functions as an arithmetic processing unit, and controls the operation of the data management apparatus 100 according to the programs and arithmetic parameters stored in the memory.

Moreover, the data management apparatus 100 comprises a communication interface configured from a communication device or the like to be connected to a network. The communication device may be a wireless LAN (Local Area Network)-compatible communication device, or a wireless USB-compatible communication device, or a wired communication device that performs wired communication. The communication device sends and receives various data, via the network, to and from a user's information processing terminal.

Moreover, the data management apparatus 100 comprises an information input device such as a keyboard, a switch, a pointing device or a microphone, and information output device such as a monitor display or a speaker.

Furthermore, the data management apparatus 100 comprises a storage device 140 for data storage. The storage device 140 includes a storage medium, a recording device for recording data in the storage medium, a reading device for reading data from the storage medium, and a deletion device for deleting data recorded in the storage medium. The storage device 140 is configured, for example, from an HDD (Hard Disk Drive), and stores programs and various data to be executed by the CPU for driving the hard disk. Moreover, in this embodiment, since voluminous time series data is stored in the storage device 140, the storage device 140 may also be configured as an external storage device that is separate from the foregoing hardware configuration.

(2-2) Software Configuration of Data Management Apparatus

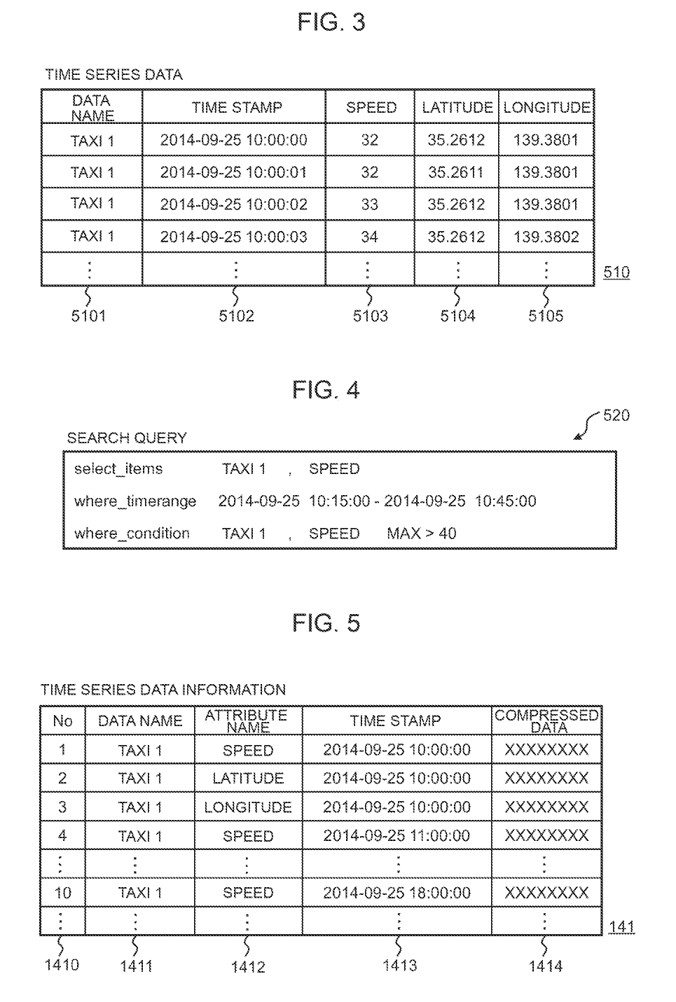

Next, referring to FIG. 2, the software configuration of the data management apparatus 100 is explained. Note that, upon explaining the software configuration of the data management apparatus 100, the various data contents illustrated in FIG. 3 to FIG. 11 will be referred to as appropriate. As shown in FIG. 2, the data management apparatus 100 is configured from a data accumulation unit 110, a data search unit 120, and a data reorganization unit 130.

The data accumulation unit 110 controls the processing of the foregoing first stage; that is, the processing of compressing and accumulating the time series data, and is configured from a data reception unit 111, a processing unit 112 and a writing unit 115.

The data reception unit 111 receives time series data 510 from an external user terminal via the network, and provides the received time series data 510 to the processing unit 112. An example of the time series data 510 is depicted in FIG. 3.

As shown in FIG. 3, the time series data 510 is configured from a data name 5101, a time stamp 5102, a speed 5103, a latitude 5104 and a longitude 5105. The data name 5101 is information indicating the measurement object for which time series data is to be measured, and, for example, is “taxi 1”, “taxi 2” or the like. The time stamp 5102 is information indicating the time that the data was stored, and is information of date and time such as “Sep. 25, 2014 10:00:00”. The speed 5103 is the speed of the measurement object “taxi 1” at the time, and, for example, is “32” or the like which indicates the speed. The latitude 5104 and the longitude 5105 are the latitude and the longitude of the measurement object “taxi 1” at the time, and, for example, are “35.2612” which indicates the latitude and “139.3801” which indicates the longitude.

The processing unit 112 acquires data in a predetermined unit of compression from the time series data provided by the data reception unit 111, the feature value calculation unit 113 calculates the feature value of the data, and the data compression unit 114 compresses the data. The feature value calculation unit 113 calculates the feature value of the data in a unit that is smaller than the unit of compression used for acquiring the data, and provides the calculated feature value to the writing unit 115.

Specifically, the feature value calculation unit 113 refers to the feature value calculation information 146, identifies the unit of calculation and the calculation method of the feature based on the data name and attribute name of the time series data, and calculates the feature value of the time series data. The data compression unit 114 compresses the data in a predetermined unit of compression, and provides the compressed data to the writing unit 115.

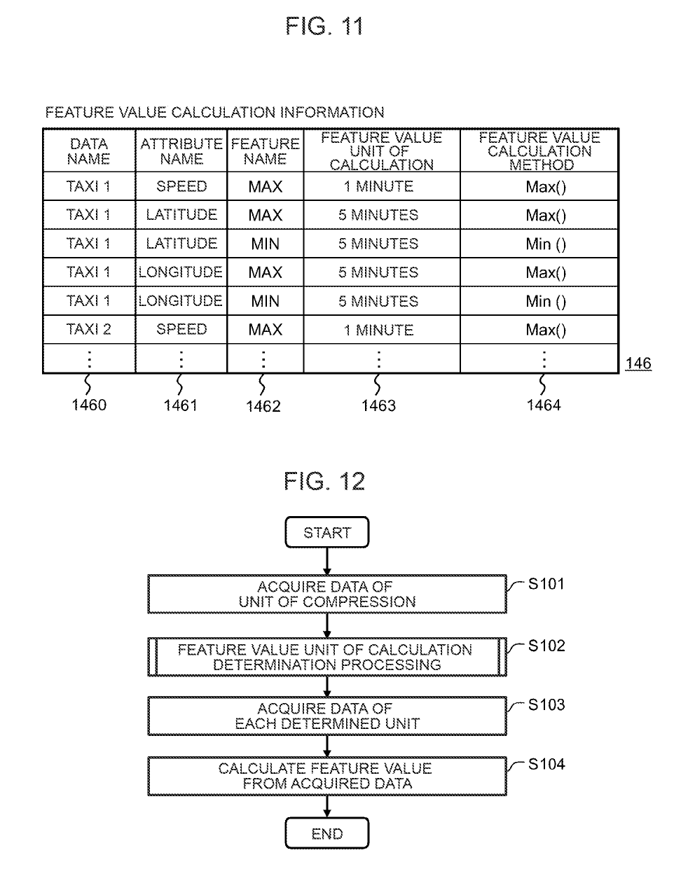

FIG. 11 shows an example of the feature value calculation information 146. The feature value calculation information 146 is information for managing the feature value unit of calculation, and is configured, as shown in FIG. 11, from a data name 1460, an attribute name 1461, a feature name 1462, a feature value unit of calculation 1463 and a feature value calculation method 1464.

The data name 1460 stores information indicating the measurement object of the time series data, and, for example, is “taxi 1”, “taxi 2” or the like. The attribute name 1461 stores information indicating the attribute of the time series data, and, for example, is “speed”, “latitude”, “longitude” or the like. The feature name 1462 stores the name of the feature value, and, for example, is “MAX” indicating the maximum value or data or “MIN” indicating the minimum value of data. The feature value unit of calculation 1463 stores information regarding the feature value unit of calculation. The feature value unit of calculation is set by the user in advance, but as described later, the feature value unit of calculation is changed according to the search history information or the like. The feature value calculation method 1464 stores the calculation formula for calculating the feature value, and, for example, is calculation formula “Max( )” for calculating the maximum value or calculation formula “Min( )” for calculating the minimum value.

The writing unit 115 is configured from a feature value writing unit 116 which stores the feature value provided by the processing unit 112 in the storage device 140, and a data writing unit 117 which stores the compressed data provided by the processing unit 112 in the data writing unit 117.

The data writing unit 117 associates the compressed data, which was compressed by the data compression unit 114, and the attribute information which identifies the data, and stores the association as the time series data information 141 in the storage device 140. An example of the time series data information 141 is shown in FIG. 5.

As shown in FIG. 5, the time series data information 141 is configured from a No. 1410, a data name 1411, a attribute name 1412, a time stamp 1413 and a compressed data 1414. The No. 1410 stores the number for identifying the time series data. The data name 1411 stores information indicating the measurement object of the time series data, and, for example, is “taxi 1”, “taxi 2” or the like. The attribute name 1412 stores information indicating the attribute of the time series data, and, for example, is “speed”, “latitude”, “longitude” or the like. The time stamp 1413 stores information indicating the time that the data was stored, and is information of the date and time such as “Sep. 25, 2014 10:00:00”. The compressed data 1414 stores the compressed data which was compressed in a predetermined unit of compression.

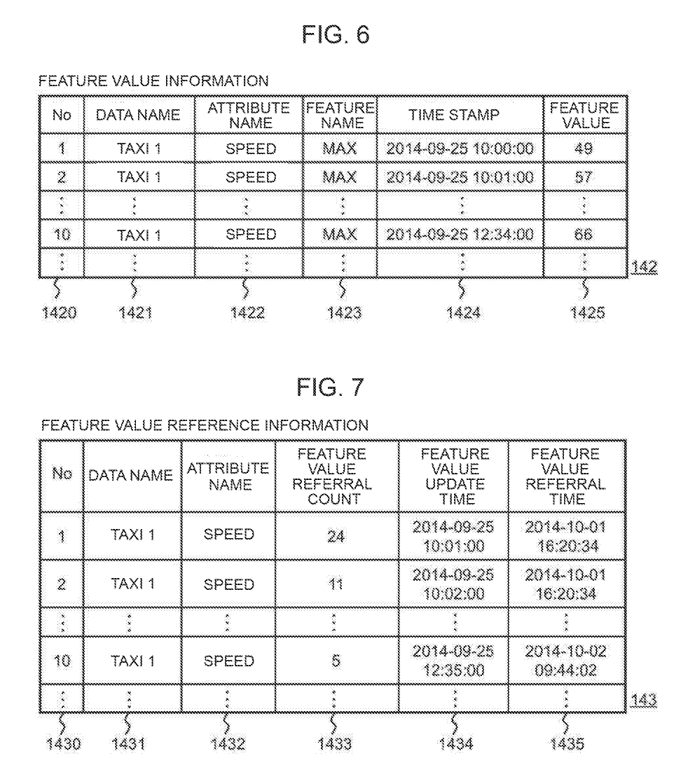

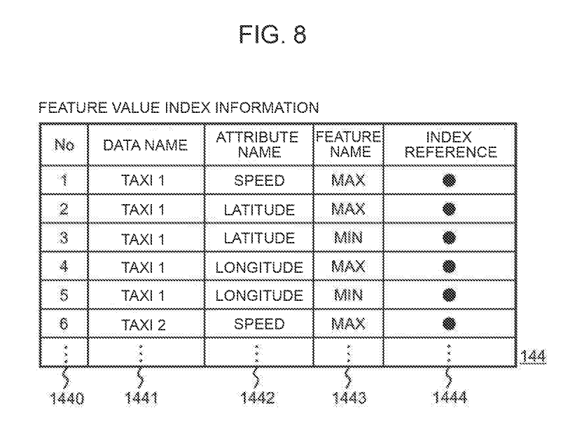

The feature value writing unit 116 associates the feature value, which was calculated by the feature value calculation unit 113, and the attribute information which identifies the data, and stores the association as the feature value information 142 in the storage device 140. As example of the feature value information 142 is shown in FIG. 6. Furthermore, the feature value writing unit 116 creates a feature value index from the feature value information 142, and stores the created feature value index as the feature value index information 144 in the storage device 140. An example of the feature value index information 144 is shown in FIG. 8.

As shown in FIG. 6, the feature value information 142 is configured from a No. 1420, a data name 1421, an attribute name 1422, a feature name 1423, a time stamp 1424 and a feature value 1425. The No. 1420 stores the number for identifying the feature value. The data name 1421 stores information indicating the measurement object of the time series data, and, for example, is “taxi 1”, “taxi 2” or the like. The attribute name 1422 stores information indicating the attribute of the time series data, and, for example, is “speed”, “latitude”, “longitude” or the like. The feature name 1423 stores the name of the feature value, and, for example, is “MAX” indicating the maximum value of data or “MIN” indicating the minimum value of data. The time stamp 1424 stores information indicating the time that the data was stored, and is information such as the date and time of “Sep. 25, 2014 10:00:00”. The feature value 1425 stores the feature value calculated according to the feature value calculation method in the feature value unit of calculation of the feature value calculation information 146.

As shown in FIG. 8, the feature value index information 144 is configured from a No. 1440, a data name 1441, an attribute name 1442, a feature name 1443 and an index reference 1444. The No. 1440 stores the number for identifying the feature value index. The data name 1441 stores information indicating the measurement object of the time series data, and, for example, is “taxi 1”, “taxi 2” or the like. The attribute name 1442 stores information indicating the attribute of the time series data, and, for example, is “speed”, “latitude”, “longitude” or the like. The feature name 1443 stores the name of the feature value, and, for example, is “MAX” indicating the maximum value of data or “MIN” indicating the minimum value of data. The index reference 1444 stores information of index data to be referred to.

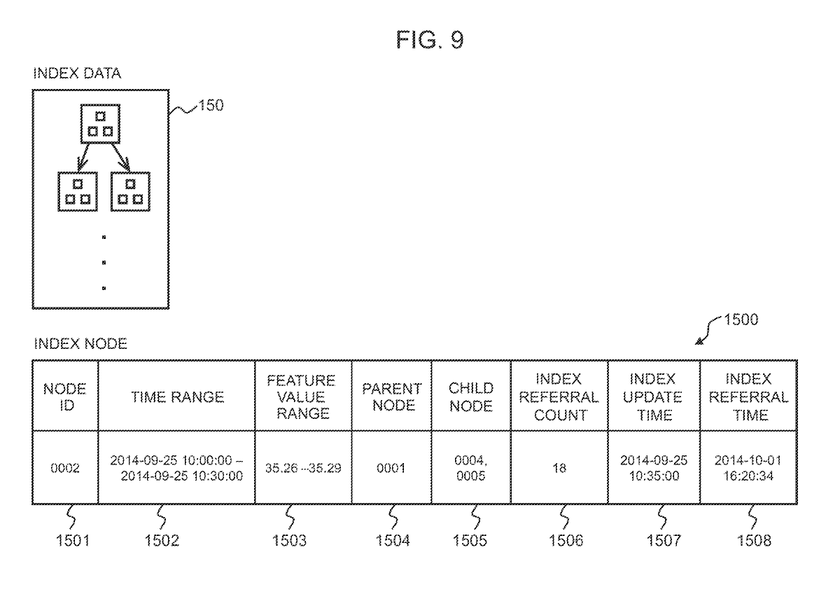

FIG. 9 shows an example of the index data designated by the index reference 1444. The index data 150 is configured from a plurality of index nodes that are hierarchized. The index node 1500 is configured, for example, from a node ID 1501, a time range 1502, a feature value range 1503, a parent node 1504, a child node 1505, an index reference count 1506, an index update time 1507 and an index reference time 1508.

The node ID 1501 is a number for identifying the index node. The time range 1502 is information indicating the time range of the feature value. The feature value range 1503 is information indicating the feature value range. The parent node 1504 is information indicating the parent node of the node. The child node 1505 is information indicating the child node of the node. The index reference count 1506 is information indicating the referral count of the index. The index update time 1507 is information indicating the update time of the index. The index reference time 1508 is information indicating the referral time of the index.

The data search unit 120 controls the processing of the foregoing second stage; that is, the processing of searching for the time series data or the feature value itself and acquiring the time series data, and is configured from a search reception unit 121, a search evaluation unit 122, a search unit 123 and a reading unit 126.

The search reception unit 121 receives a search query 520 from an external user terminal via a network, and provided the received search query 520 to the search evaluation unit 122. An example of the search query 520 is shown in FIG. 4.

As shown in FIG. 4, the search query 520 is inquiry information used for searching the time series data, and includes a search target (select_items), a search duration (where_time range), and a search condition (where_condition). For example, when the search query is “select_items taxi 1; speed, where_time range Sep. 25, 2014 10:15:00-Sep. 25, 2014 10:45:00, where_condition taxi 1; speed; MAX>40”, this means that a search for data in which the search target is the speed of taxi 1, the search duration is from Sep. 25, 2014; 10:15 to Sep. 25, 2014; 10:45, and the maximum value of the speed of taxi 1 is 40 km or faster has been requested.

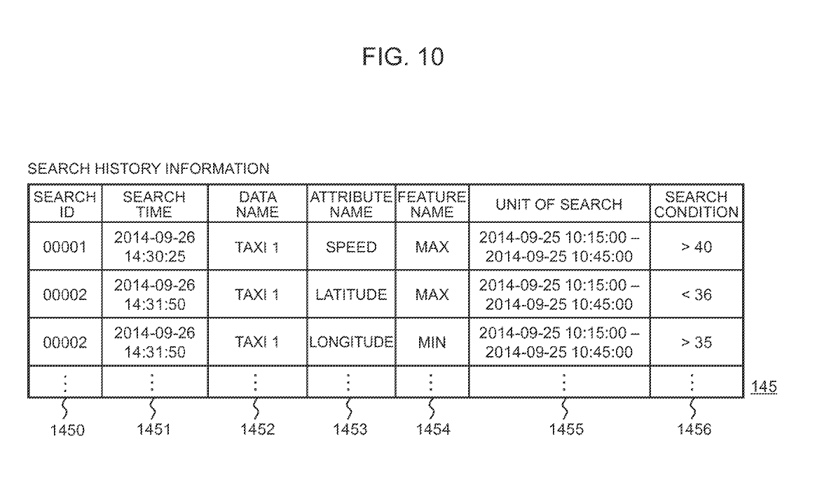

The search evaluation unit 122 evaluates the search query 520 provided by the search reception unit 121. Specifically, the search evaluation unit 122 identifies the search conditions such as the data name and attribute name of the search target and the search target period from the foregoing search query 520, and provides the identified items to the search unit 123. Moreover, the search evaluation unit 122 stores the evaluation result of the search query 520 as the search history information 145 in the storage device 140. An example of the search history information 145 is shown in FIG. 10.

As shown in FIG. 10, the search history information 145 is configured from a search ID 1450, a search time 1451, a data name 1452, an attribute name 1453, a feature name 1454, a unit of search 1455 and a search condition 1456.

The search ID 1450 stores the number for identifying the search history. The search time 1451 stores the time that the search was performed. The data name 1452 stores the data name of the search target. The attribute name 1453 stores the attribute name of the search target. The feature name 1454 stores the name of the feature value of the search target, and, for example, is “MAX indicating that the feature value is a maximum value or “MIN” indicating that the feature value is a minimum value. The unit of search 1455 stores information regarding the unit of search, and, for example, the time range of the search target is stored. The search condition 1456 stores information indicating the search condition, and, for example, is “>40” indicating that cases where the feature value “MAX” (maximum value) is greater than 40 are to be searched, or “<36” indicating that cases where the feature value “MIN” (minimum value) is smaller than 36 are to be searched.

The search unit 123 is configured from a feature value search unit 124 which searches the feature value, and a data search unit 125 which searches the time series data. The feature value search unit 124 searches for the corresponding feature value from the feature value information 142 based on the search target, the search target period and the search condition identified by the search evaluation unit 122. The feature value search unit 124 reflects the search result of the feature value in the feature value reference information 143 and the feature value index information 144.

An example of the feature value reference information 143 is shown in FIG. 7. As shown in FIG. 7, the feature value reference information 143 is configured from a No. 1430, a data name 1431, an attribute name 1432, a feature value referral count 1433, a feature value update time 1434 and a feature value referral time 1435.

The No. 1430 stores the number for identifying the feature value, and the feature value of the feature value information 142 of FIG. 6 above is associated based on this number. The data name 1431 stores information indicating the measurement object of the time series data. The attribute name 1432 stores information indicating the attribute of the time series data. The feature value referral count 1433 stores the referral count of the feature value. The feature value update time 1434 stores the update time of the feature value. The feature value referral time 1435 stores the referral time of the feature value.

Note that the feature value reference information 143 is stored as a table that is different from the foregoing feature value information 142, the feature value referral frequency including the feature value referral count 1433, the feature value update time 1434 and the feature value referral time 1435 of the feature value reference information 143 may also be added to the feature value information 142 and integrated to be one table.

Moreover, the feature value search unit 124 updates the index reference count 1506, the index update time 1507 and the index reference time 1508 of the index node 1500 shown in FIG. 9.

Subsequently, the data search unit 125 searches for the time series data corresponding to the feature value searched by the feature value search unit 124 from the time series data information 141. Details regarding the search processing of the feature value and the search processing of the time series data will be described later.

The reading unit 126 is configured from a feature value reading unit 127 which reads the feature value, and a data reading unit 128 which reads the time series data. The feature value reading unit 127 reads the data of the feature value identified by the feature value search unit 124 from the feature value information 142 stored in the storage device 140. Moreover, the data reading unit 128 reads the time series data identified by the data search unit 125 from the time series data information 141 stored in the storage device 140.

The data reorganization unit 130 controls the processing of the foregoing third stage; that is, processing of re-calculating or reorganizing the feature value or the feature value index from the search history information of the time series data or the referral frequency of the feature value, and is configured from a feature value reorganization unit 131 and a feature value index reorganization unit 132.

The feature value reorganization unit 131 refers to the search history information 145, compares the unit of search of the search history information 145 and the feature value unit of calculation set by the feature value calculation information 146, changes the feature value unit of calculation, and calculates that feature value as the second feature value. Specifically, the feature value reorganization unit 131 calculates, as the second feature value, a feature in a unit (for example 15-minute units) that is different from the unit of search (for example 1-minute units) calculated by the feature value calculation unit 113.

As described above, the result from the search performed by the user based on the search query 520 is stored as the search history information 145 in the storage device 140. For example, let it be assumed that the feature value is calculated in 1-minute units by the feature value calculation unit 113. Meanwhile, let it be assumed that the unit of search 1455 of the search history information 145 is 15-minute units, and that the feature value is being frequently searched. In the foregoing case, the feature value is calculated in 15-minute units and not in 1-minute units, or the feature value of 15-minute units is calculated in addition to the feature value of 1-minute units. Accordingly, by dynamically changing the unit of calculation according to the search history or retaining a plurality of units of calculation, optimal feature values according to the user's search or data contents can be provided.

For example, in cases where the feature value unit of calculation is 1-minute units and the unit of search is 15-minute units, it is necessary to acquire data corresponding to 15 feature values, decompress the data, and re-calculate the feature values. Nevertheless, as a result of calculating the feature value of 15-minute units as the second feature value, the corresponding data can be searched by using the feature values calculated in 15-minute units without having to decompress the data and re-calculating the feature values.

Moreover, in cases where the data contents are changing moment by moment or the needs of the search searching for data search are changed, by retaining the feature values calculated in 15-minute units in addition to the feature values calculated in 1-minute units and thereby retaining a plurality of feature values of different units, it will be possible to flexibly deal with various types of search processing.

Moreover, the feature value reorganization unit 131 refers to the search history information 145, and, when the search is being performed by using a plurality of feature values, calculates a new feature value as the third feature value based on the search result from the search performed using a plurality of feature values. Specifically, when the search is being performed by using a plurality of feature values, the feature value reorganization unit 131 may set a flag of “1” when the condition of designating a plurality of feature values is satisfied, and sets a flag of “0” when such condition is not satisfied and thereby set a value that differs from the plurality of feature values as the third feature value, and can thereby more quickly execute the search processing.

Moreover, the feature value reorganization unit 131 compresses and stores the feature value according to the referral frequency of the feature value. Among the feature values calculated by the feature value calculation unit 113, by compressing and storing the feature values having a low referral frequency, the storage capacity can be conserved. It is thereby possible to conserve the data storage capacity while retaining a variety of feature values according to the user's search needs.

The feature value index reorganization unit 132 refers to index referral frequency information such as the index reference count 1506, the index update time 1507 and the index reference time 1508 of the feature value index information 144, and thereby reorganizes the feature value index data.

(3) Data Management Method

Among the foregoing first stage processing (compression/accumulation stage), second stage processing (search/acquisition stage) and third stage processing (reorganization stage), the feature value calculation processing and the feature value reorganization processing are now specifically explained in detail with reference to FIG. 12 to FIG. 22. Note that, in the ensuing explanation, while the processing subject of the various types of processing is explained as each function part (program), in effect, it goes without saying that the CPU of the data management apparatus 100 executes the processing based on the program of each function part.

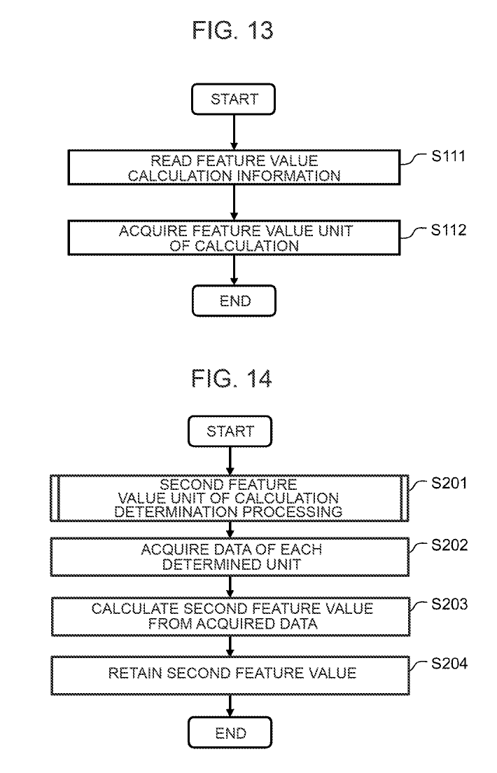

The feature value calculation processing performed by the feature value calculation unit 113 is foremost explained with reference to FIG. 12 and FIG. 13. As shown in FIG. 12, foremost, the feature value calculation unit 113 acquires data of a unit of compression (S101). Subsequently, the feature value calculation unit 113 executes the feature value unit of compression determination processing (S102).

The feature value unit of compression determination processing of step S102 is now explained with reference to FIG. 13. As shown in FIG. 13, the feature value calculation unit 113 reads the feature value calculation information 146 illustrated in FIG. 11 (S111), and thereafter acquires the feature value unit of calculation from the feature value calculation information 146 (S112).

Returning to FIG. 12, the feature value calculation unit 113 extracts and acquires, from the data acquired in step S101, the data for each feature value unit of calculation determined in step S102 (S103). Subsequently, the feature value calculation unit 113 calculates, from the data acquired in step S103, the feature value based on the feature value unit of calculation acquired in step S112 (S104).

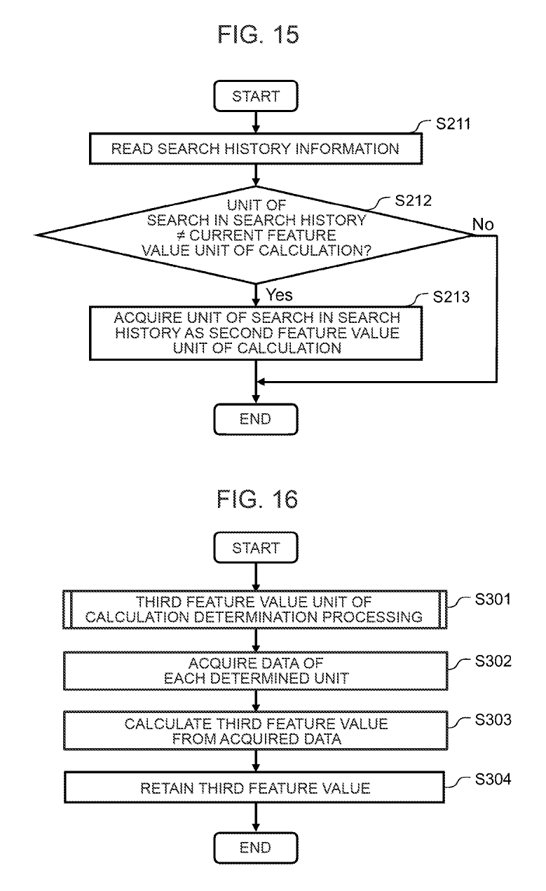

The second feature value calculation processing performed by the feature value reorganization unit 131 is now explained with reference to FIG. 14 and FIG. 15. As shown in FIG. 14, the feature value reorganization unit 131 executes the second feature value unit of calculation determination processing (S201).

The second feature value unit of calculation determination processing of step S201 is now explained with reference to FIG. 15. As shown in FIG. 15, the feature value reorganization unit 131 reads the search history information 145 stored in the storage device 140 (S211).

Subsequently, the feature value reorganization unit 131 determines whether the unit of search in the search history and the current feature value unit of calculation are different (S212). Specifically, the feature value reorganization unit 131 compares the unit of search 1455 of the search history information 145 and the current unit of calculation of the corresponding feature value; that is, compares the unit of search 1455 of the search history information 145 and the feature value unit of calculation set in the feature value calculation information 146. For example, with the search history information 145, the feature value of data name “taxi 1”, attribute name “speed”, and feature name “MAX” is being frequently searched in 15-minute units, and, when the feature value unit of calculation of data name “taxi 1”, attribute name “speed”, and feature name “MAX” of the feature value calculation information 146 is 1 minute, the determination in step S212 would be negative.

In step S212, when it is determined that the unit of search in the search history and the current feature value unit of calculation are different, the feature value reorganization unit 131 acquires the unit of search in the search history information 145 as the second feature value unit of calculation (S213). Meanwhile, in step S212, when it is determined that the unit of search in the search history and the current feature value unit of calculation are equal, the feature value reorganization unit 131 ends this processing.

Returning to FIG. 14, the feature value reorganization unit 131 acquires, from the time series data 510, data based on the second feature value unit of calculation determined in step S201 (S202). Subsequently, the feature value reorganization unit 131 calculates, from the data acquired in step S202, the second feature value based on the second feature value unit of calculation acquired in step S213 (S203), and retains the second feature value as the feature value of the feature value information 142 (S204).

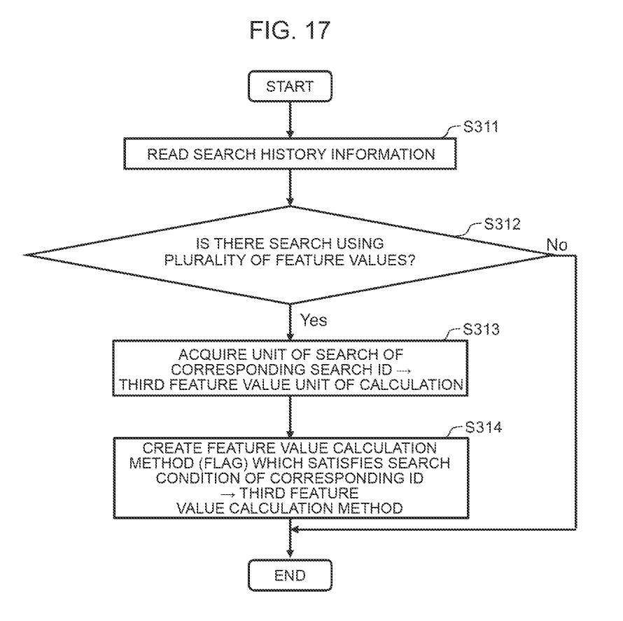

The third feature value calculation processing of the feature value reorganization unit 131 is now explained with reference to FIG. 16 and FIG. 17. As shown in FIG. 16, the feature value reorganization unit 131 executes the third feature value calculation method determination processing (S301).

The third feature value calculation method determination processing of step S301 is now explained with reference to FIG. 17. As shown in FIG. 17, the feature value reorganization unit 131 reads the search history information 145 stored in the storage device 140 (S311).

Subsequently, the feature value reorganization unit 131 refers to the search history information 145, and determines whether there is a search that used a plurality of feature values (S312). Specifically, the feature value reorganization unit 131 determines whether a plurality of same search IDs exist. For example, in the search history information 145 of FIG. 10, two search IDs of “0002” exist. Based on these two search IDs “0002”, this shows that the search is being conducted under the conditions of the maximum value of latitude “is smaller than 36” and the minimum value of latitude is “greater than 35” by using the two feature values of the maximum value of latitude and the minimum value of latitude.

In step S312, when it is determined that there is a search that used a plurality of feature values, the feature value reorganization unit 131 acquires the unit of search of that search ID, and uses the acquired unit of search as the third feature value unit of calculation (S313). Subsequently, the feature value reorganization unit 131 creates a feature value calculation method that satisfies the search condition of that search ID, and stores the created feature value calculation method as the third feature value calculation method (S314).

Specifically, when a search is being conducted using two or more feature values, the feature value reorganization unit 131 sets a flag of “1” when the condition of designating a plurality of feature values is satisfied, and sets a flag of “0” when such condition is not satisfied and thereby sets a value that differs from the plurality of feature values as the third feature value. The flag as the third feature value is associated with the corresponding feature value and stored in the feature value information 142.

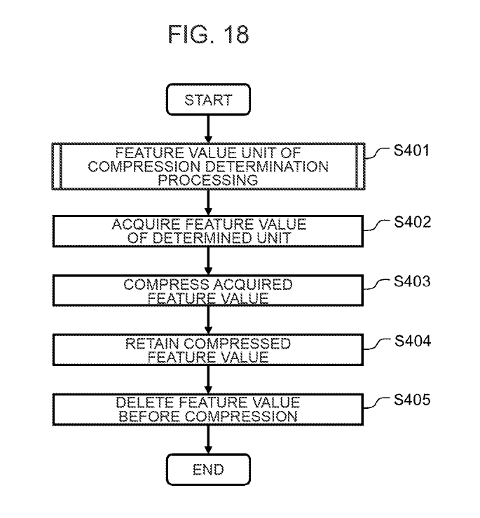

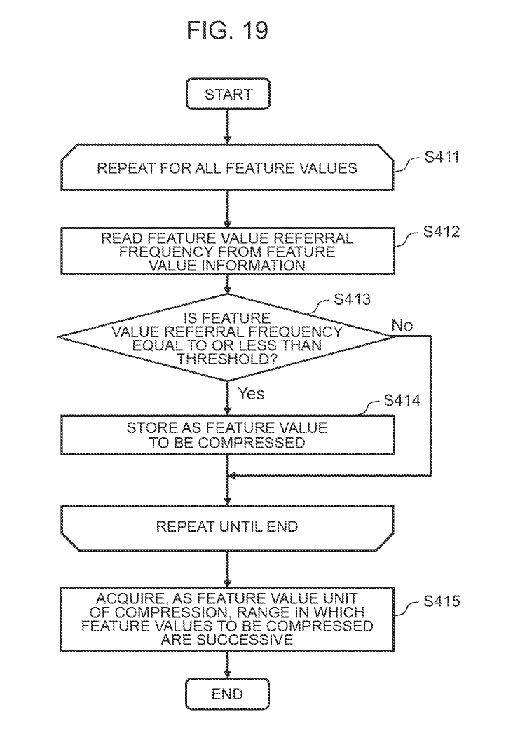

The feature value compression processing performed by the feature value reorganization unit 131 is now explained with reference to FIG. 18 and FIG. 19. As shown in FIG. 18, the feature value reorganization unit 131 executes the feature value unit of compression determination processing (S401).

The feature value unit of compression determination processing of step S401 is now explained with reference to FIG. 19. As shown in FIG. 19, the feature value reorganization unit 131 executes the processing of step S412 to step S414 to all feature values of the feature value information 142. The feature value reorganization unit 131 reads the feature value referral frequency from the feature value information 142 (S412). Specifically, the feature value reorganization unit 131 reads the feature value referral frequency including the feature value referral count 1433, the feature value update time 1434 and the feature value referral time 1435 of the feature value information 142.

Subsequently, the feature value reorganization unit 131 determines whether the feature value referral frequency is equal to or less than the threshold (S413). Specifically, the feature value reorganization unit 131 determines whether the feature value referral frequency is equal to or less than the threshold based on the following method. For example, the feature value reorganization unit 131 may determine that the referral frequency of the feature value is low when the difference between the current time and the feature value referral time 1435 of the feature value reference information 143 is equal to or greater than a predetermined threshold. Moreover, the feature value reorganization unit 131 may determine that the referral frequency of the feature value is low when a predetermined period has elapsed from the feature value update time 1434 and the difference between the current time and the feature value referral time 1435 falls within the lower 5%. Moreover, the feature value reorganization unit 131 may determine that the referral frequency of the feature value is low when a predetermined period has elapsed from the feature value update time 1434 and the feature value referral count 1433 is equal to or less than the threshold. Moreover, the feature value reorganization unit 131 may determine that the referral frequency of the feature value is low when a predetermined period has elapsed from the feature value update time 1434 and the feature value referral count 1433 falls within the lower 5% of the feature value.

In step S413, when it is determined that the feature value referral frequency is equal to or less than the threshold based on the foregoing determination, the feature value reorganization unit 131 stores that feature value as a feature value to be compressed (S414). Meanwhile, in step S413, when it is determined that the feature value referral frequency is not equal to or less than the threshold, the feature value reorganization unit 131 repeats the processing of step S412 onward.

Subsequently, after repeating the processing of step S411 to step S414 to all feature values, the feature value reorganization unit 131 acquires the range of successive feature values to be compressed as the feature value unit of compression (S415).

Returning to FIG. 18, the feature value reorganization unit 131 acquires the feature values of the unit determined in step S401 (S402). Subsequently, the feature value reorganization unit 131 compresses the feature values acquired in step S402 (S403), and retains the compressed feature values (S404). The feature value reorganization unit 131 thereafter deletes the feature values before compression (S405).

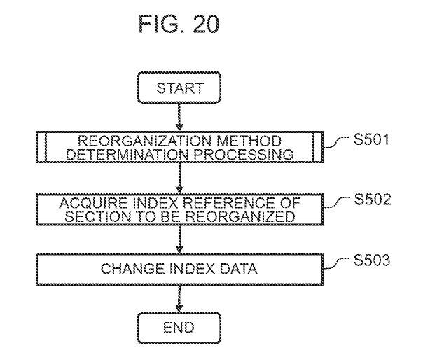

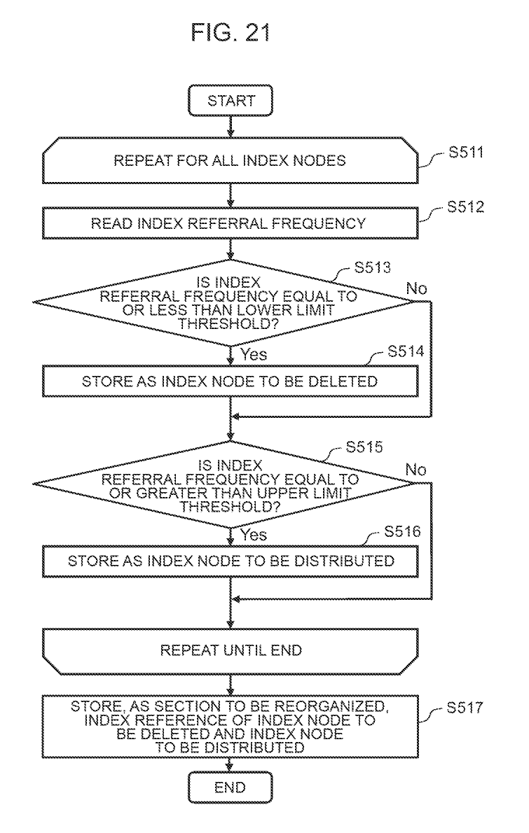

The feature value index reorganization processing performed by the feature value index reorganization unit 132 is now explained with reference to FIG. 20 and FIG. 21. The feature value index reorganization unit 132 executes the feature value index reorganization method determination processing (S501).

The feature value index reorganization method determination processing of step S501 is now explained with reference to FIG. 21. As shown in FIG. 21, the feature value index reorganization unit 132 repeats the processing of step S511 to step S516 to all index nodes 1500.

The feature value index reorganization unit 132 reads the index referral frequency of the index node 1500 (S512). Specifically, the feature value index reorganization unit 132 reads the index referral frequency including the index reference count 1506, the index update time 1507 and the index reference time 1508 of the index node 1500.

Subsequently, the feature value reorganization unit 131 determines whether the index referral frequency is equal to or less than the lower limit threshold (S513). In step S513, the index referral frequency and the lower limit threshold are compared based on the index reference count 1506, the index update time 1507 and the index reference time 1508 in the same manner as the determination in step S413. The lower limit threshold is a threshold that is used for determining whether to delete the index node based on the index reference count 1506, the index update time 1507 and the index reference time 1508.

In step S513, when it is determined that the index referral frequency is equal to or less than the lower limit threshold, the feature value reorganization unit 131 stores that index node as an index node to be deleted (S514). Meanwhile, in step S513, when it is determined that the index referral frequency is not equal to or less than the lower limit value, the feature value reorganization unit 131 executes the processing of step S515.

Subsequently, the feature value reorganization unit 131 determines whether the index referral frequency is equal to or greater than the upper limit threshold (S515). In step S515, the upper limit threshold is a threshold that is used for determining whether the index node is frequently searched and whether to divide the index node based on the index reference count 1506, the index update time 1507 and the index reference time 1508.

Returning to FIG. 20, the feature value reorganization unit 131 acquires, from the feature value index information 144, the index reference which includes an index node determined to be deleted or divided in the reorganization method determination processing and stored as the reorganization location (S502).

Subsequently, the feature value reorganization unit 131 changes the index node of the index data corresponding to the index reference acquired in step S502 (S503). Specifically, the feature value reorganization unit 131 deletes the index node stored as the index node to be deleted in step S514 or divides the index node stored as the index node to be divided in step S516.

Note that, based on the foregoing processing, the feature value reorganization unit 131 may restore the deleted index nodes or combined the divided index nodes based on the index referral frequency regarding the index nodes that were deleted or divided.

Moreover, in the second feature value calculation processing, the third feature value calculation processing and the feature value compression processing performed by the feature value reorganization unit 131, or in the feature value index reorganization processing performed by the feature value index reorganization unit 132, it is also possible to presented the calculated feature value unit of calculation, the compression location of the feature value or the reorganization location of the index data to the user and have the user select whether to use the calculation result, and thereafter calculate the new feature value or reorganize the feature value index.

For example, when there are changes to the contents of the time series data or the search needs of the user, by selecting the new feature value unit of calculation calculated based on the foregoing processing, it is possible to perform a more effective search. Moreover, in cases where the contents of the time series data are only temporarily changed or the user's search method is merely changed, the user may also continue the intended search by using the current feature value unit of calculation without selecting the presented new feature value unit of calculation.

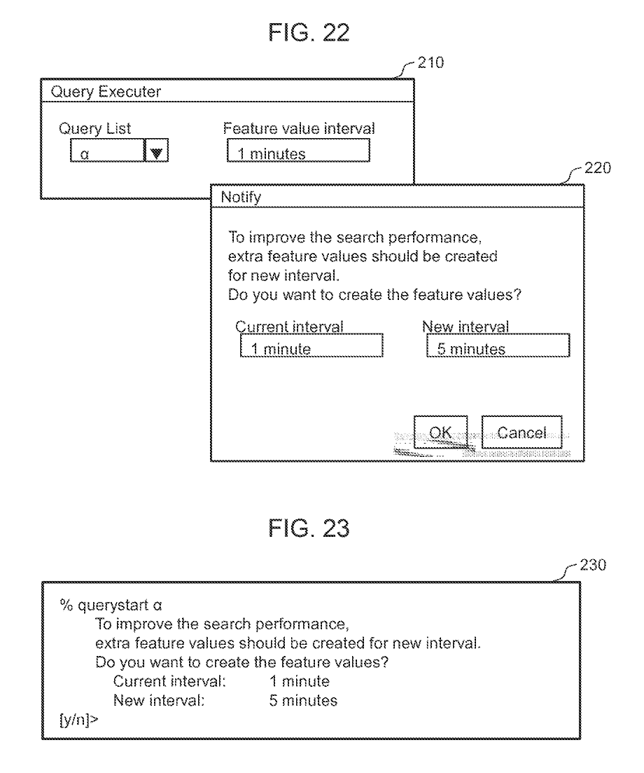

The selection and input of the feature value unit of calculation by the user is now explained with reference to FIG. 22 and FIG. 23. FIG. 22 and FIG. 23 are examples of the feature value unit of calculation selection screen.

The display screen examples 210 and 220 shown in FIG. 22 are the new feature value unit of calculation selection screens calculated as the second feature value based on the second feature value calculation processing among the foregoing feature value reorganization processing. For example, the display screen example 210 shows that 1 minute has been set as the feature value unit of calculation regarding the query (Query List) a corresponding to the feature value. Moreover, the display screen example 220 shows that the current feature value unit of calculation is 1 minute, and the newly calculated feature value unit of calculation is 5 minutes. As a result of the user pressing the “OK” button of the display screen example 220, the user can choose to calculate the feature values in 5-minute units. Moreover, by the user pressing the “Cancel” button, the user may continue to use the current feature value unit of calculation and calculate the intended feature value without changing the feature value unit of calculation.

Moreover, the display screen example 230 shown in FIG. 23 is also a new feature value unit of calculation selection screen calculated as the second feature value based on the second feature value calculation processing as with FIG. 22. As a result of the user inputting a command prompt “[yin]>” and subsequently inputting a “y” command, the user can select 5 minutes as the new feature value unit of calculation. Moreover, when there is no need to change the feature value unit of calculation, the user may input an “n” command and continue to use the current feature value unit of calculation and calculate the intended feature value without changing the feature value unit of calculation.

(4) Other Embodiments

Moreover, while the foregoing embodiments explained a case where, as an example of the time series data, the speed information and the location information of a taxi are accumulated in predetermined intervals, and the maximum speed and the minimum speed of a taxi are calculated as the feature value in predetermined intervals (feature value unit of calculation), the present invention is not limited to the foregoing example. For example, information which indicates the loss/non-loss of data may be calculated as the feature value, and whether there is any loss of data may be determined based on the feature value.

In the foregoing case also, as with the foregoing embodiments, the feature value is calculated in a unit that is smaller than the unit of compression. Consequently, even when the unit of compression is a large unit such as per day, whether there is any loss of data can be determined in a smaller unit, such as per minute, and it is thereby possible to efficiently perform a more detailed high-precision data analysis.

Moreover, with the foregoing embodiments, while the point in time that the speed has been exceeded is searched from the speed information of the taxi included in the time series data, the present invention is not limited to the foregoing example. For instance, the traffic violation status of a taxi may be search by using location information and direction information included in the time series data, and map information including various traffic information such as one-way streets and stop signs.

### REFERENCE SIGNS LIST

100: Data management apparatus
110: Data accumulation unit
111: Data reception unit
112: Processing unit
113: Feature value calculation unit
114: Data compression unit
115: Writing unit
116: Feature value writing unit
117: Data writing unit
120: Data search unit
121: Search reception unit
122: Search evaluation unit
123: Search unit
124: Feature value search unit
125: Data search unit
126: Reading unit
127: Feature value reading unit
128: Data reading unit
130: Data reorganization unit
131: Feature value reorganization unit
132: Feature value index reorganization unit
140: Storage device
141: Time series data information
142: Feature value information
143: Feature value reference information
144: Feature value index information
145: Search history information
146: Feature value calculation information

1. A data management apparatus, comprising:
a data reception unit which acquires data in a first unit from time series data that was input;
a data compression unit which compresses the data acquired in the first unit; and
a feature value calculation unit which calculates a feature value indicating a feature of data acquired in a second unit that differs from the first unit.

2. The data management apparatus according to claim 1,
wherein the second unit is a unit that is smaller than the first unit, and
wherein the feature value calculation unit calculates the feature value of data acquired in the second unit.

3. The data management apparatus according to claim 2, further comprising:
a writing unit which associates data information of data acquired in the second unit and a feature value of the data calculated by the feature value calculation unit and writes the association in a storage device.

4. The data management apparatus according to claim 3,
wherein the writing unit associates data information of data acquired in the second unit and index data for searching the feature value and writes the association in the storage device.

5. The data management apparatus according to claim 3, further comprising:
a data search unit which receives a search request of the time series data,
wherein the data search unit searches for the feature value corresponding to a search scope and a search condition included in the search request, and
wherein the writing unit stores a search result of the feature value as search history information in the storage device.

6. The data management apparatus according to claim 4, further comprising:
a feature value reorganization unit which reorganizes the feature value calculated by the feature value calculation unit,
wherein, when a duration of the search scope of the search history information and a duration of the second unit are different, a second feature value of data acquired in a third unit, which is the duration of the search scope, is calculated.

7. The data management apparatus according to claim 6,
wherein, when a plurality of feature values are included in the search condition of the search history information, the feature value reorganization unit sets, as a third feature value, a flag indicating whether conditions for designating the plurality of feature values are satisfied.

8. The data management apparatus according to claim 5,
wherein the writing unit, based on the search history information, associates the feature value, and referral frequency information of the feature value including a referral count of the feature value, an update time of the feature value or a referral time of the feature value, and writes the association in the storage device.

9. The data management apparatus according to claim 8,
wherein, when the referral frequency information of the feature value is equal to or less than a predetermined threshold, the feature value reorganization unit sets the feature value as a feature value to be compressed.

10. The data management apparatus according to claim 5,
wherein the index data is configured from a plurality of hierarchies based on a plurality of index nodes including a search scope, a range of the feature value, a parent node and a child node, and
wherein the writing unit, based on the search history information, associates each of the index nodes, and referral frequency information of indexes including a referral time of an index, an update time of an index and a referral time of an index, and writes the association in the storage device.

11. The data management apparatus according to claim 10, further comprising:
an index data reorganization unit which reorganizes the index data,
wherein, when the referral frequency information of the index is equal to or less than a predetermined threshold, the index data reorganization unit sets the index node as an index node to be deleted, and when the referral frequency information of the index is greater than a predetermined threshold, the index data reorganization unit sets the index node as an index node to be divided.

12. A data management method for managing time series data that was input, comprising:
a step of a data reception unit acquiring data in a first unit from time series data that was input;
a step of a data compression unit compressing the data acquired in the first unit; and
a step of a feature value calculation unit calculating a feature value indicating a feature of data acquired in a second unit that differs from the first unit.
